(19) United States
(12) Patent Application Publication
(10) Pub. No.: US 2005/0045621 A1
(43) Pub. Date: Mar. 3, 2005

(54) Bathing unit control system with capacitive water level sensor

(76) Inventors: Francois Chenier, Quebec (CA); Christian Brochu, Quebec (CA); Benoit Laflamme, Quebec (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/651,949

(22) Filed: Sep. 2, 2003

(51) Int. Cl. H05B 1/02

(52) U.S. Cl. 219/490

(57) ABSTRACT

A control system suitable for use in a bathing unit comprises a device including a body through which water can flow, and a capacitive water level sensor adapted for obtaining a capacitance measurement associated to a level of water in the device. The control system further comprises a processing unit in communication with the capacitive water level sensor for generating a control signal on the basis of the capacitance measurement, the control signal being operative for controlling the device. The device may include a heating module, a pump or any other suitable device in fluid communication with the water of the bathing unit.

### FIELD OF THE INVENTION

The present invention relates to the field of control systems for bathing units, and more specifically, to control systems including water level sensors for detecting a level of water in components of the bathing unit.

### BACKGROUND OF THE INVENTION

A bathing unit often includes a water holding receptacle, pumps to circulate water in a piping system, a heating module to heat the water, a filter system, an air blower, a lighting system, and a control system for activating and managing the various parameters of the bathing unit components. Examples of bathing units include spas, whirlpools, hot tubs, bathtubs and swimming pools.

In use, the pumps typically circulate the water of the bathing unit through the heating module in order to heat the water. The heating device is typically controlled by the control system which selectively activates/deactivates the heating device in order to set the water in the bathing unit at a desired temperature. A consideration associated with the heating of the water is the risk of damage to the heating module and to the adjacent bathing unit components and piping system when the heating element becomes too hot. The risk of damage due to overheating is increased in new bathing units since the current trend is to construct heating modules with plastic components. Plastic components are lighter, less costly to manufacture and are subject to less corrosion than their equivalent metallic components. Considering that plastic materials have thermal properties generally inferior to metallic materials, the early detection of situations where the heating element is overheated is desirable.

More particularly, an overheating situation can sometimes lead to a condition commonly referred to as a dry fire. Dry fires occur when there is no water in the heating module or when the flow of water is too weak to remove enough heat from the heating module. An insufficient level of water in the heating module can occur as a result, for example, of a blockage in the piping system, of a dirty filter system preventing the normal flow of water in the heating module or from simply a low water level in the water holding receptacle.

In order to prevent the occurrence of dry fire, systems have been designed to detect low water level conditions in heating devices such as to prevent the heating device from being activated when the water level is too low.

A proposed solution for detecting a low water level condition is the use of a water flow detection switch positioned to detect the flow of water into the heating device. When the water flow detection switch detects an insufficient flow of water through the heating device, it prevents the heating device from being activated. A deficiency in such systems is that the components used for detecting the flow of water into the heating pipe are exposed to the water and therefore are subject to corrosion and, in the case of mechanical sensors, to mechanical drift.

Another proposed solution is described in U.S. Pat. No. 6,355,913 issued to Authier et al. on Mar. 12, 2002. The contents of the above document are incorporated herein by reference. In the system described, an infrared sensor is mounted to the heating device and is positioned such as to sense the infrared radiation emitted by a heating element of the heating device as its temperature increases. When the infrared sensor senses infrared radiation emitted by heating element that is greater than a predetermined high limit level, it prevents the heating device from being activated. A deficiency with systems of the type described above is that the infrared sensor is subject to some thermal inertia which influences its response time.

Another proposed solution includes the use of optical components that exploit the difference between the respective optical refraction indices of water and air. A deficiency with such solutions is that these optical systems are affected by deposits on their optical surfaces and therefor require regular cleaning.

Another proposed solution is described in U.S. Pat. No. 6,476,363 issued to Authier et al. on Nov. 5, 2002. The contents of the above document are incorporated herein by reference. In the system described, a resistor device having a resistance that varies with the water level is used to detect the presence of water. A deficiency with systems of the type described above is that the resistor devices of such systems are affected by deposits and chemicals in the water, which affect the sensitivity and accuracy of these systems.

In addition, devices in the bathing unit other that the heating device, such as water pumps, may be damaged when operating with insufficient water in the pipes in which they are installed. Existing systems offer no suitable manner for detecting low water level conditions in such devices.

Against the background described above, it appears that there is a need in the industry to provide a control system suitable for a bathing unit that alleviates at least in part the problems associated with the existing control systems.

### SUMMARY OF THE INVENTION

In accordance with a broad aspect, the invention provides a control system suitable for use in a bathing unit. The control system comprises a heating module including a body defining a passage through which water can flow, and a capacitive water level sensor adapted for obtaining a capacitance measurement associated to a level of water in the heating module. The control system further comprises a processing unit in communication with the capacitive water level sensor for generating a control signal on the basis of the capacitance measurement, the control signal being operative for controlling the heating module.

In a specific implementation, the body of the heating module includes an electrically non-conductive portion. Alternatively, the body of the heating module is entirely comprised of an electrically non-conductive material.

In accordance with a second non-limiting implementation, the capacitive water level sensor includes a capacitor element and a capacitance measurement device in communication with the capacitor element. The capacitance measurement device is operative to derive the capacitance measurement by obtaining a measurement of a capacitance associated to the capacitor element.

In a non-limiting implementation, the capacitor element includes a first electrically conductive member and a second electrically conductive member. The first electrically conductive member and the second electrically conductive member are connected to the electrically non-conductive portion of the body of the heating module in a capacitive relationship with one another.

In a specific implementation, the electrically non-conductive portion of the body of the heating module includes an outer surface and an inner surface. The first electrically conductive member and the second electrically conductive member are connected to the outer surface of the heating module.

In a non-limiting implementation, the processing unit is adapted to generate a control signal for causing the heating module to be deactivated when the capacitance measurement is associated to a water level below a threshold water level. Optionally, the processing unit is adapted to generate a control signal for allowing the heating module to be activated when the capacitance measurement is associated to a water level of at least a threshold water level.

In a non-limiting implementation, the processing unit is operative for generating a status signal conveying information associated to a level of water in the heating module, and for transmitting the status signal to a monitoring unit for conveying the information to a human operator. Optionally, the information conveyed by the status signal includes the level of water in the heating module.

In accordance with another broad aspect, the invention provides a spa system comprising a spa shell defining a receptacle for holding water. The spa system further comprises a heating module in fluid communication with the receptacle defined by the spa shell, the heating module including a body defining a passage through which water can flow. The spa system also comprises a capacitive water level sensor adapted for obtaining a capacitance measurement associated to a level of water in the heating module, and a processing unit in communication with the capacitive water level sensor for generating a control signal on the basis of the capacitance measurement, the control signal being operative for controlling the heating module.

In accordance with yet another broad aspect, the invention provides a control system suitable for use in a bathing unit. The control system comprises heating module means through which water can flow and capacitive water level sensor means adapted for obtaining a capacitance measurement associated to a level of water in the heating module means. The control system further comprises means for generating a control signal on the basis of the capacitance measurement, the control signal being operative for controlling the heating module means.

In accordance with yet another broad aspect, the invention provides a control system suitable for use in a bathing unit. The control system comprises a device having body defining a passage through which water can flow and a capacitive water level sensor adapted for obtaining a capacitance measurement associated to a level of water in the body of the device. The control system also comprises a processing unit in communication with the capacitive water level sensor for generating a control signal on the basis of the capacitance measurement for controlling the device.

In specific implementations, the device may include either one of a heating module, a pump or any other suitable device adapted for being positioned in fluid communication with the water in the bathing unit.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of examples of implementation of the present invention is provided hereafter with reference to the following drawings, in which:

FIG. 1 shows a spa system equipped with a control system in accordance with an example of implementation of the present invention;

FIG. 2 shows a block diagram of a control system including a capacitive water level sensor suitable for use in a spa system in accordance with an example of implementation of the present invention;

FIG. 3 shows a block diagram of a capacitive water level sensor suitable for use in the control system shown in FIG. 2 in accordance with a first specific example of implementation of the control system of the present invention;

FIGS. 4a and 4b show graphical representations of electric field lines between conductive plates;

FIGS. 5a, 5b, 5c and 6 show graphical representations of the resulting capacitance of a non-conductive body in combination with either air or water;

FIGS. 7a,b,c to 9a,b,c show alternative implementations of capacitor elements suitable for use in the capacitive water level sensor of FIG. 3 in accordance with specific examples of implementation of the present invention;

FIG. 10 shows a first specific example of implementation of a capacitance measurement device suitable for use in the capacitive water level sensor shown in FIG. 3;

FIG. 11 shows a second specific example of implementation of a capacitance measurement device suitable for use in the capacitive water level sensor shown in FIG. 3;

FIG. 12 shows a block diagram of a control system including a capacitive water level sensor suitable for use in a spa system in accordance with another aspect of the present invention.

In the drawings, embodiments of the invention are illustrated by way of example. It is to be expressly understood that the description and drawings are only for the purposes of illustration and as an aid to understanding, and are not intended to be a definition of the limits of the invention.

### DETAILED DESCRIPTION

The description below is directed to a specific implementation of the invention in a spa system. It is to be understood that the term “spa”, as used for the purposes of the present description, refers to spas, whirlpools, hot tubs, bath tubs, swimming pools and any other type of bathing receptacle that can be equipped with a control system for controlling various operational settings.

In addition, the present description describes in detail a specific implementation of the invention where the device for which the water level is being monitored is a heating device. It is to be understood that the concepts described herein below are also applicable when the device is a spa pump or any other suitable device adapted for being positioned in fluid communication with the water in the spa.

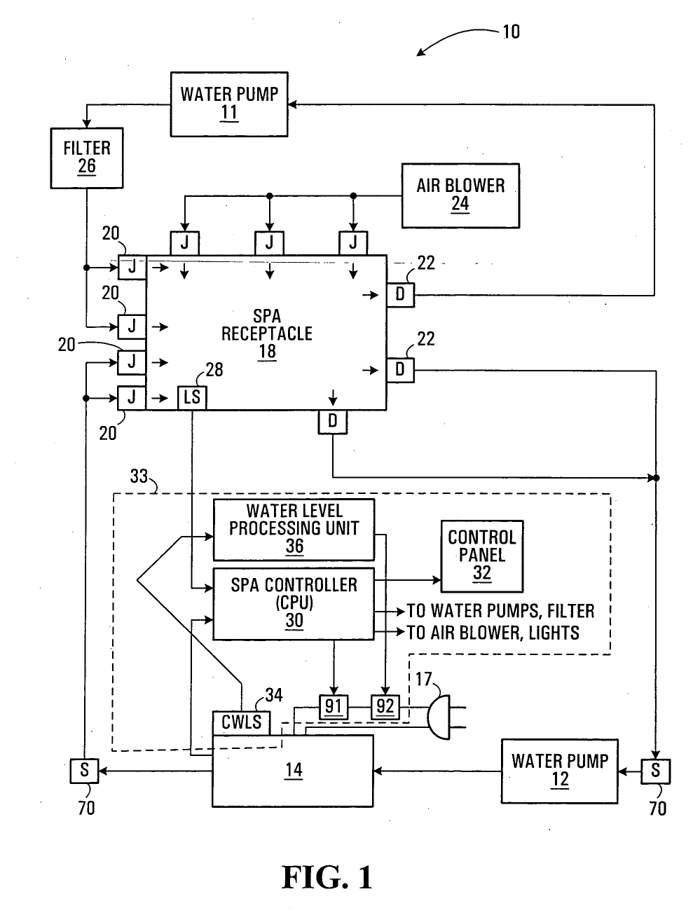

FIG. 1 illustrates a block diagram of a spa system 10 that is equipped with a control system in accordance with a specific example of implementation of the present invention. The spa system 10 includes a spa receptacle 18 for holding water, a plurality of jets 20, one or more water pumps 11 & 12, a set of drains 22, a heating device 14 and a control system 33. In normal operation, water flows from the spa receptacle, through the drain 22 and is pumped by water pump 12 through heating module 14 where the water is heated. The heated water then leaves the heating module 14 and re-enters the spa receptacle 18 through jets 20. Water leaves the spa receptacle 18 through drains 22 and the cycle is repeated.

Optionally, the spa system 10 also include an air blower 24 for delivering air bubbles to the spa receptacle 18, a filter 26 to clean particulate impurities in the water, a light system 28 and any other suitable device for use in connection with a spa. In normal operation, water flows from the spa receptacle, through the drain 22 and is pumped by water pump 11 through filter 26 and re-enters the spa receptacle 18 through jets 20.

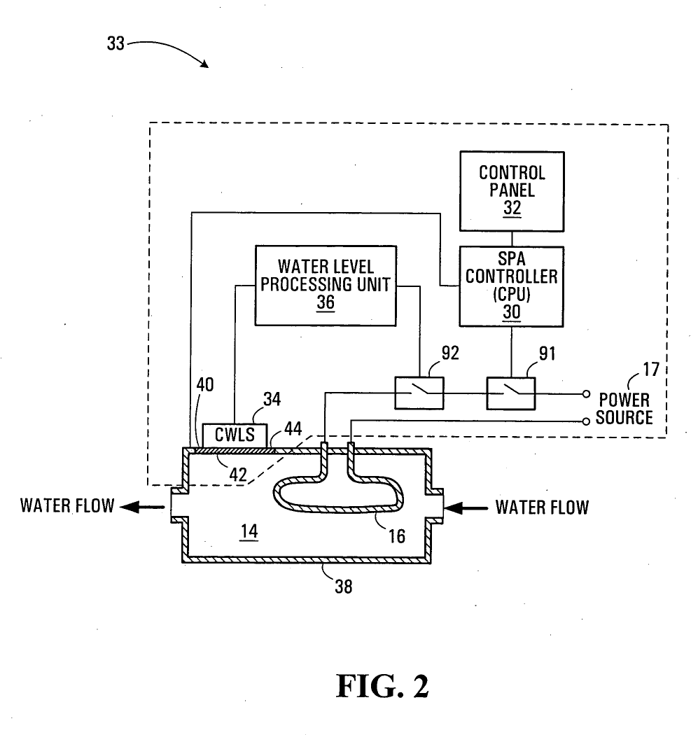

The control system 33 is for controlling the various components of the spa system 10. The control system 33 is described in greater detail with reference to FIG. 2. In a non-limiting implementation, the control system includes a control panel 32, a spa controller 30, a water level processing unit 36 and a plurality of sensors and actuators including a capacitive water level sensor 34. The control panel 32 is typically in the form of a user interface allowing a user to control various operational settings of the spa. Some non-limiting examples of operational settings of the spa include a temperature control setting, jet control settings and lighting settings.

The heating module 14 includes a body 38 defining a passage through which water can flow and an electric heating element 16 to transfer heat to the water flowing through the passage. The heating element 16 is powered by a suitable power source 17 such as a standard household electric circuit. It is to be understood that the water flow passage and heating element 16 can take various respective configurations without departing from the spirit and scope of the present invention. Also, the present invention could be adapted to a heating module 14 including other types of heating elements, such as a gas heater. In an alternative implementation, the heating element includes heating surface components positioned on the outer and/or inner surfaces of the body 38 of the heating module.

The body 38 of the heating module 14 includes an electrically non-conductive portion 40 having an inner surface 42 and an outer surface 44. The expression “electrically non-conductive material” refers to a class of materials having substantially low electrical conductivity properties such as plastics, elastomers, ceramics, and selected composite materials. Moreover, the body 38 of the heating module 14 may include a plurality of electrically non-conductive portions or may be made entirely such of such electrically non-conductive materials. In a specific practical implementation, the body of the heating module is comprised of plastic and includes one or more conductive parts for providing an electrical path between the water in the heating module 14 and ground.

The capacitive water level sensor 34 is adapted for obtaining a capacitance measurement associated to a level of water in the heating module 14.

In a specific implementation, the capacitance measurement is measured on the basis of a level of water within the boundaries of the heating module 14. In an alternative implementation, the capacitance measurement is measured on the basis of a level of water in a pipe adjacent to the heating module 14 but not within the boundaries of the heating module 14 per se. Since the water level in the pipes adjacent to the heating module 14 should be substantially similar to the water level in the pipes, obtaining a capacitance measurement on the basis of a level of water in a pipe adjacent to the heating module 14 provides an indirect manner for measuring the water level in the heating module 14.

The water level processing unit 36 is in communication with the capacitive water level sensor 34 for processing the capacitance measurement to generate a control signal for controlling the heating module 14. In the specific implementation shown in FIG. 2, the control signal released by the water level processing unit 36 is used for controlling a switch or relay 92 which controls the supply of power to the heating module from a power source 17. As shown in FIG. 2, spa controller 30 is also adapted for releasing a control signal for controlling switch or relay 91 which also controls the supply of power to the heating module from a power source 17. Spa controller 30 receives control signals from the control panel 32 and from a temperature probe adapted for measuring water temperature in the spa system. In this fashion, the heating module is enabled (or turned “ON”) in the situation where both the control signals released by the water level processing unit 36 and the spa controller 30 cause the switches 91 and 92 to allow the supply of power to reach the heating module 14. It will be appreciated that although two switches/relays 91 and 92 are shown in the figures, implementations of the invention in which a single switch/relay that can be controlled by both the water level processing unit 36 and the spa controller 30 may be used without detracting from the spirit of the invention.

In an alternative implementation (not shown in the figures), the control signal released by water level processing unit 36 is provided to the spa controller 30. The spa controller includes programming logic adapted for processing the control signal received from water level processing unit 36 in combination with other parameters such as desired water temperature, current water temperature and so on, to derived a combined control signal for controlling the supply of power between the heating module 14 and power source 17. In this alternative implementation, one switch or relay may be used.

In yet another alternative implementation (not shown in the figures), the capacitance measurement is provided to the spa controller 30. The spa controller includes programming logic adapted for processing the capacitance measurement in combination with other parameters such as desired water temperature, current water temperature and so on, to derived a combined control signal for controlling the supply of power between the heating module 14 and power source 17. In this alternative implementation, one switch or relay may be used.

For the purpose of clarity, in the present description, the spa controller 30 and the water level processing unit 36 are being shown as separate components each releasing control signals to the components of the spa system 10. It will be appreciated that the functionality of the water level processing unit 36 and spa controller 30 may be partially or fully integrated with one another without detracting from the spirit of the invention. For example, practical implementations of the invention may have either separate physical components for the spa controller 30 and the water level processing unit 36 or a same component where the functionality of the water level processing unit 36 and spa controller 30 are integrated.

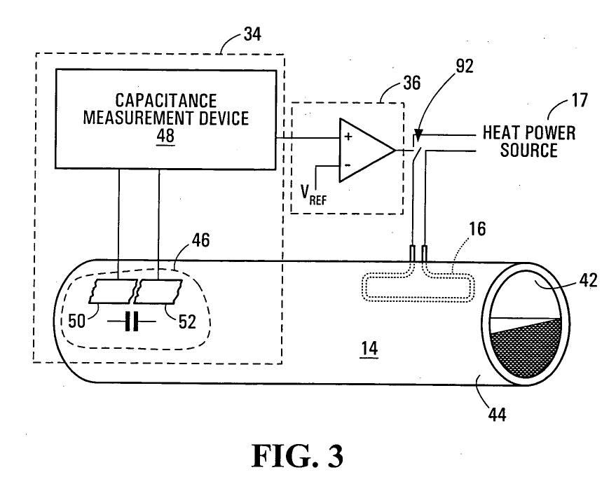

In a first non-limiting example of implementation shown in FIG. 3, the capacitive water level sensor 34 includes a capacitor element 46 and a capacitance measurement device 48 in communication with the capacitor element 46. The capacitance measurement device 48 is operative to obtain a measurement of a capacitance associated to the capacitor element 46. The measured value of the capacitance of the capacitor element 46 is associated to the level of water in the heating module 14. Optionally, the capacitive water level sensor 34 provides a mapping between capacitance measurement and actual water levels.

Capacitor Element 46

In a specific example of implementation, the capacitor element 46 includes first and second electrically conductive members 50 and 52 that are respectively connected to an electrically non-conductive portion 40 of the heating module 14.

It will be appreciated that, in alternative embodiments, first and second electrically conductive members 50 and 52 may be positioned on an electrically non-conductive portion of a pipe in fluid communication with the heating module 14. Preferably, the first and second electrically conductive members 50 and 52 will be placed in a position on the pipe adjacent to the heating module 14 such that the water level in the pipe is substantially similar to the water level in the heating module. For the purpose of simplicity, the following description is directed to first and second electrically conductive members 50 and 52 connected to an electrically non-conductive portion 40 of the heating module 14 only. The person skilled in the art will readily appreciate that the description below may be applied to a pipe adjacent to the water heater without detracting from the spirit of the invention.

The first and second electrically conductive members 50 and 52 are made of a material having a substantially high electrical conductivity property, such as a metal or a metal alloy.

The first and second electrically conductive members 50 and 52 are in a capacitive relationship with one another, with the capacitance between the plates varying in dependence of the level of water in the heating module 14.

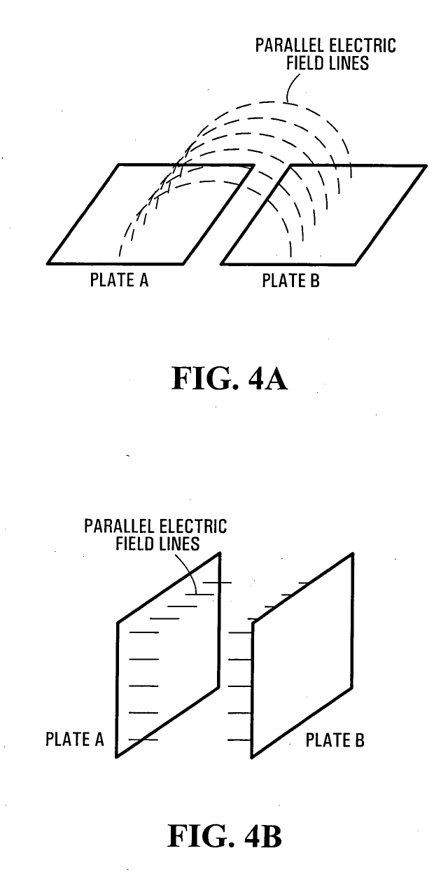

Generally stated, capacitance is a well-known phenomenon used in electronics and the mathematical equations by which capacitance can be calculated are also well known. In particular, the theory shows that for two parallel plates facing each other, the capacitance is proportional to the area of the plates, to a value called a dielectric constant and inversely proportional to the distance separating the plates. FIG. 4a shows the electrical field lines between two parallel plates facing each other. More complex equations can be derived for complex shapes and plate spacing. When the two plates are positioned side to side instead of facing each other, the electric field lines between the two plates will tend to look more like half-concentric circles than straight lines. FIG. 4b shows the electrical field lines between two parallel plates positioned side to side. Typically, capacitance may be measured by a circuit involving a capacitor as a reference component, an oscillator associated with a frequency measurement or a time constant circuit with a timing measurement.

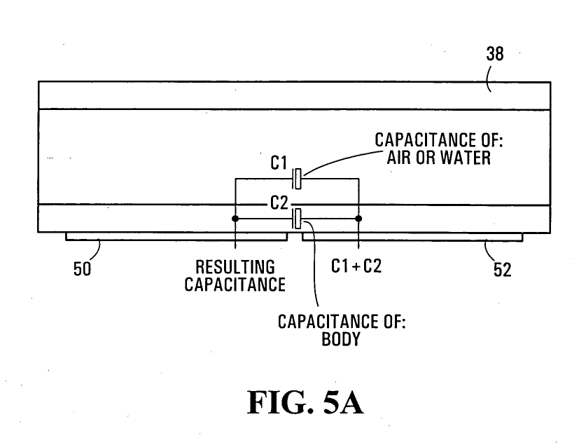

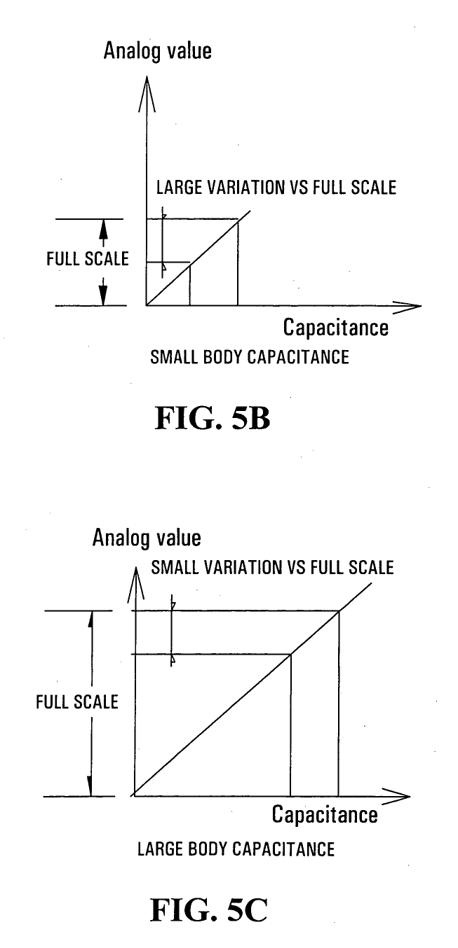

Wither reference to the embodiment shown in FIG. 3, the first and second electrically conductive members 50 and 52 are positioned substantially side by side and therefor the electric field lines between the two plates will tend to look more like half-concentric circles than straight lines. In the absence of water (or liquid), the dielectric between the two plates is comprised of air and of the non-conductive body of the heating device 14. In the presence of water (or liquid), the dielectric between the two plates is comprised of water and of the non-conductive body of the heating device 14. As illustrated in FIG. 5a of the drawings, the non-conductive body 38 of the heating device 14 acts as a parallel capacitance with either air or water. The dielectric constant of air is 1, whereas the dielectric constant of water is 60 to 80. Therefore, the capacitance varies in the same ratio.

In a specific implementation, the capacitance of the body of the heating device is kept to a minimum so as to maximize the variation of capacitance. As can be seen in FIG. 5b, when the capacitance of the body is small compared to the range of available capacitance, the variation of capacitance due to presence of water is proportionally significant and as such can be more easily detected by a measurement circuit. As can be seen in FIG. 5c, when the capacitance of the body becomes preponderant, due to its thickness for example, the variation of capacitance due to presence of water is proportionally less significant and as such becomes less detectable by the measurement circuit.

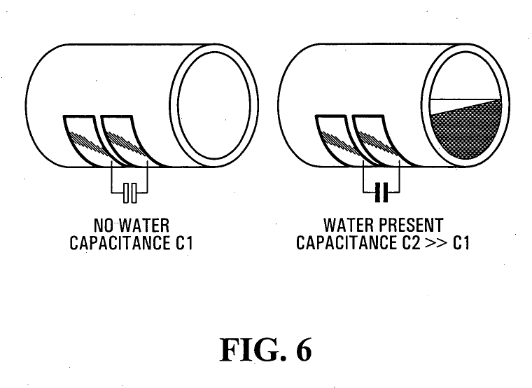

As illustrated in FIG. 6, the level of water in the heating module 14 directly influences the average dielectric constant of the medium between the first and second electrically conductive members 50 and 52, thereby influencing the capacitance associated to the capacitor element 46. Accordingly, a measurement of the capacitance associated to the capacitor element 46 may be used to provide an indication of the level of water in the heating module 14.

In the embodiment shown in FIG. 3, the first and second electrically conductive members 50 and 52 are connected to the outer surface 44 of the electrically non-conductive portion 40.

Advantageously, connecting the first and second electrically conductive members 50 and 52 to the outer surface 44 of the non-conductive portion 40 prevents water flowing in the heating module 14 to contact the capacitor element 46, thereby substantially decreasing the rate of corrosion and degradation of the capacitor element 46. In addition, the isolation of the capacitor element 46 from the flow of water renders the capacitive water level sensor 34 substantially insensitive to the water temperature or to variations thereof. Moreover, the isolation of the capacitor element 46 from the flow of water significantly reduces electrical insulation problems as well as the potential of electrical shock hazards associated with the possible maintenance or repair of the heating module 14 by an individual.

In an alternative implementation (not shown in the figures), the first and second electrically conductive members 50 and 52 are connected to the inner surface 42 of the electrically non-conductive portion 40. Advantageously, connecting the first and second electrically conductive members 50 and 52 to the outer surface 44 of the non-conductive portion 40 allows the resulting capacitance to be substantially independent from the material of the body of the heating device.

In yet another alternative implementation (not shown in the figures), one of the first and second electrically conductive members 50′ and 52 is connected to the inner surface 42 of the electrically non-conductive portion 40 and the other one of the first and second electrically conductive members 50 and 52 is connected to the outer surface 44. In yet another alternative implementation (not shown in the figures), the first and second electrically conductive members 50 and 52 are positioned at an intermediate location between the inner surface 42 and outer surface. Electrical connection extending from the first and second electrically conductive members 50 and 52 are provided for connection to the capacitance measurement circuit 48.

In a non-limiting implementation, the first and second electrically conductive members 50 and 52 are positioned in close proximity to each other and have an area that covers a large portion of the non-conductive portion of the heating device 14. Advantageously, this configuration allows a large variation of capacitance values to be available, so that a capacitance measurement can be easily done. This configuration also provides a capacitance with reduced influence from parasitic elements of the detection circuit which is also desirable.

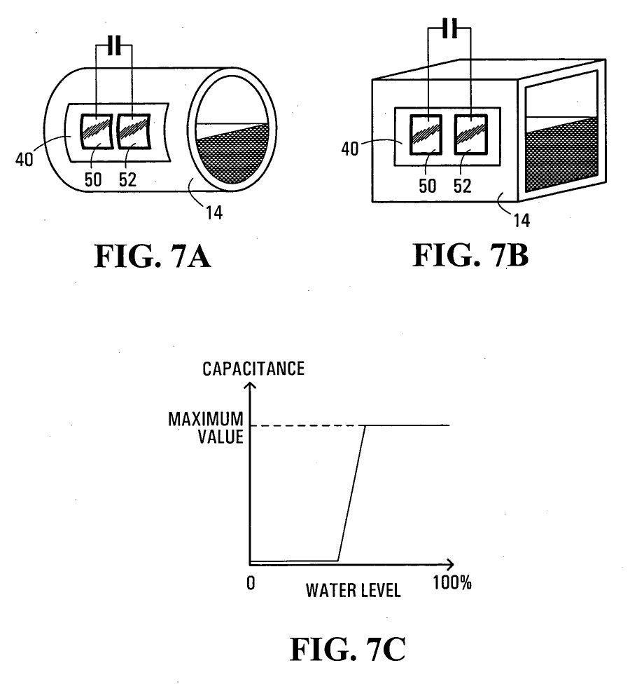

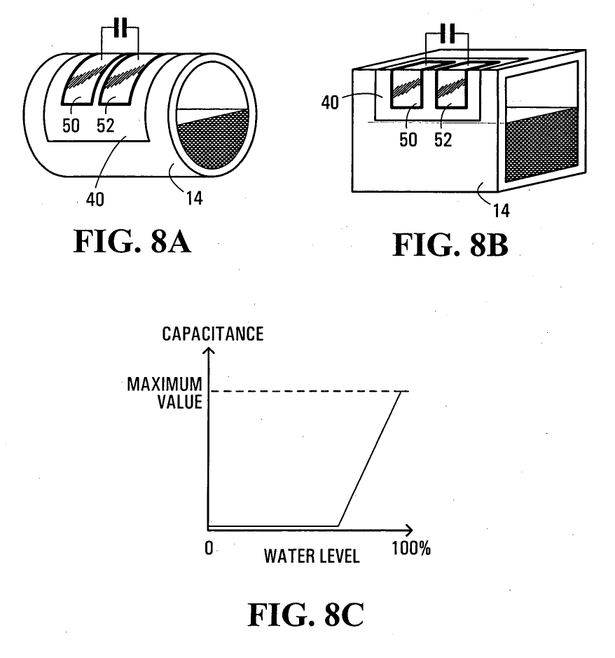

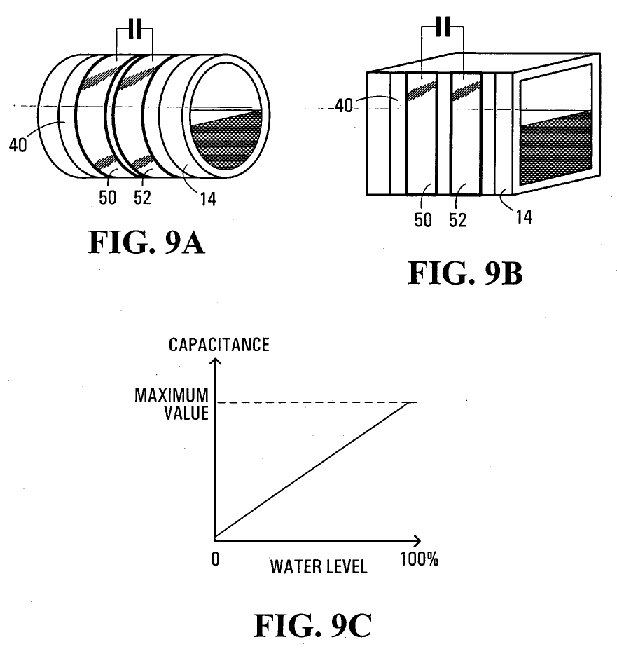

The capacitor element 46 is adapted to acquire a plurality of capacitance values, the capacitance values corresponding to levels of water in the heating module 14 in a range of levels of water. Referring to FIGS. 7a,b-9a,b, the first and second electrically conductive members 50 and 52 of the capacitor element 46 may be positioned in various configurations with respect to the heating module 14. In FIGS. 7a and 7b, the electrically conductive members 50 and 52 are positioned on a region of the heating module 14 such as to provide an indication that the water level in the heating module 14 reaches a predetermined level. In this case, the predetermined level generally corresponds to the region of the body 38 of the heating module 14 where the members 50 and 52 are positioned. FIG. 7c is a diagram showing in the change in the capacitance value between first and second electrically conductive members 50 and 52 as the water level changes in the heating module 14, when the first and second electrically conductive members 50 and 52 are in either one of the configurations shown in FIG. 7a or 7b.

In FIGS. 8a and 8b, the electrically conductive members 50 and 52 are positioned on a region of the heating module 14 such as to detect a water level in the heating module 14 that is at least at a minimum level. In this case, the members 50 and 52 extend from a region of the body 38 of the heating module 14 that generally corresponds to the minimum level of water to be detected to a higher region of the body 38, such as the top of the body 38 in the case of the configurations shown in FIGS. 8a and 8b. FIG. 8c is a diagram showing in the change in the capacitance value between first and second electrically conductive members 50 and 52 as the water level changes in the heating module 14, when the first and second electrically conductive members 50 and 52 are in either one of the configurations shown in FIG. 8a or 8b.

In FIGS. 9a and 9b, the electrically conductive members 50 and 52 are positioned on a region of the body 38 of the heating module 14 such as to provide an indication of substantially any level of water in the heating module 14. In this case, the members 50 and 52 extend over the body 38 from a region generally corresponding to the bottom or lowest level of the body 38 to a region generally corresponding to the top or highest level of the body 38. FIG. 9c is a diagram showing in the change in the capacitance value between first and second electrically conductive members 50 and 52 as the water level changes in the heating module 14, when the first and second electrically conductive members 50 and 52 are in either one of the configurations shown in FIG. 9a or 9b.

The person skilled in the art will appreciate that these various configurations have been provided for the purpose illustration of only. It is to be understood that various other configurations of the body 38 of the heating module 14 and capacitor element 46 are possible without departing from the spirit and scope of the invention.

Capacitance Measurement Device 48

With reference to FIG. 3, the capacitance measurement device 48 is in communication with the capacitor element 46 and is adapted for obtaining a measurement indicative of the capacitance of capacitor element 46.

In a first specific embodiment, the capacitance measurement device 48 is adapted for applying a current to the capacitor element 46 and for measuring a duration of time for a voltage drop across the capacitor element 46 to go from an initial voltage to a final voltage. The capacitance measurement device 48 is further adapted for generating the measurement of the capacitance associated to the capacitor element 46 at least in part on the basis of the measured duration of time.

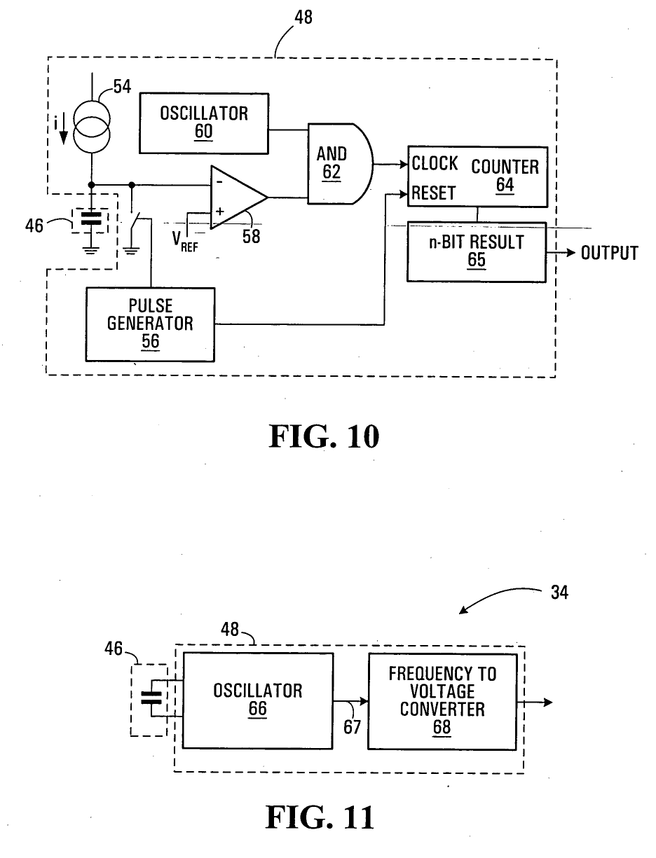

A non-limiting implementation of the first specific embodiment is shown in FIG. 10. As depicted, the capacitance measurement device 48 includes a current source 54 for applying a current to and charging the capacitor element 46, and circuitry for measuring the time taken to charge the capacitor element 46 from an initial predetermined voltage difference to a final reference voltage difference. The circuitry includes a pulse generator 56, a comparator 58, an oscillator 60, an AND gate 62, and a counter 64. A start pulse generated by the pulse generator 56 resets the counter 64 and the sets the capacitor element 46 to an initial voltage difference. In response to the start pulse, the current source 54 starts charging the capacitor element 46 and the counter 64 counts pulses generated by the oscillator 60. The charging of the capacitor element 46 and the counting of the oscillator pulses continues until the voltage difference across the capacitor element 46 reaches the final reference voltage difference V_{REF}, resulting in the comparator 58 generating an output signal that closes the AND gate 62. At that point, the digital value 65 at the output of the counter 64 represent the duration of time to charge the capacitor element 46 from the initial voltage difference to the final reference voltage difference. With a known current applied by the current source 54, the capacitance associated to the capacitor element 46 may be obtained on the basis of the duration of time represented at the digital output 65 of the counter 64 by noting that the capacitance is equal to the product of the current and the duration of time divided by the difference between the final and initial voltage drops across the capacitor element.

Mathematically, when current source 54 is a constant current source, this can be expressed as follows:

$$C \frac{\partial V}{dt} = I$$

$${\int }_{t0}^{tfinal} C \frac{ⅆ V}{ⅆ t} = {\int }_{t0}^{tfinal} I ⅆ t$$

$$C ( Vfinal - Vinitial ) = I \times ( {t}_{final} - {t}_{0} )$$

$$C = \frac{I \times ( {t}_{final} - {t}_{0} )}{( Vfinal - Vinitial )}$$

$$Now if \frac{I}{( Vfinal - Vinitial )} is a constant , then the capacitance may be expressed as \text{:}$$

$$C = K \times ( {t}_{final} - {t}_{0} )$$

Where K is a constant value. If the capacitance is divided by the constant K, a normalized capacitance Cₙₒᵣₘₐₗ may be obtained which is a function of the duration of time for charging the capacitor element 46. Mathematically, this can be expressed as follows:

$${C}_{normal} = \frac{C}{K} = ( {t}_{final} - {t}_{0} )$$

It is to be understood that various other configurations for the circuitry of the capacitance measurement device 48 may be employed without departing from the spirit and scope of the invention. In addition, it is also to be understood that the functionality of the circuitry such as the oscillator 60, AND gate 62, and counter 64 may be assembled using discrete components or may be implemented by a combination of hardware and software.

In a second non-limiting example of implementation of the capacitance measurement device 48, shown in FIG. 11, the capacitance measurement device 48 includes an oscillator 66 in an operative relationship with capacitor element 46 and adapted for releasing a signal 67 characterized by an oscillating frequency. The capacitance measurement device 48 further includes a processing module 68 adapted to derive a signal indicative of a level of water in the heating module 14 at least in part on the basis of the oscillating frequency of the signal 67.

The oscillating frequency of the signal released by the oscillator 66 is dependent at least in part on the capacitance of the capacitor element 46. The level of water in the heating module 14 influences the capacitance between the first and second electrically conductive members 50 and 52, which in turn influences the oscillating frequency of the signal released by the oscillator 66. The processing module 68 determines the capacitance associated to the capacitor element 46 on the basis of the oscillating frequency of the signal released by the oscillator 66. For example, the processing module 68 may include a frequency-to-voltage converter to convert the oscillating frequency into a voltage that can be mapped to a capacitance value. Such mappings are well-known in the field of electrical engineering and as such will not be described further here.

It will be appreciated that any suitable device for measuring a capacitance associated with capacitor element 46 may be used without detracting from the spirit of the invention.

Processing Unit 36

With reference to FIG. 3, the processing unit 36 is in communication with the capacitive water level sensor 34 and processes capacitance measurement in order to generate a control signal operative for controlling the heating module 14. The generated control signal is adapted to cause the heating module 14 to be deactivated when the capacitance measurement is associated to a water level that is below a threshold water level.

Many possible implementations of the processing unit 36 may be used here without detracting from the spirit of the invention. Such implementations may include the use of a microprocessor, digital circuitry, analog circuitry and so on. In addition, as indicated above, the functionality of the processing unit 36 may be integrated into the spa controller 30 or may be a separate component to provided added redundancy.

Broadly stated, the processing unit 36 is adapted to compare the capacitance measurement to a threshold capacitance associated to the threshold water level in order to derive the control signal. When the capacitance measurement is below the threshold capacitance, the control signal causes the heating module 14 to be deactivated. The threshold capacitance may be a predetermined capacitance or may be a configurable parameter of processing unit 36. When the threshold capacitance is a configurable parameter, the control system is provided with an input (not shown in the figures) for receiving a configuration signal. The input may be in any suitable form such as a serial link, a dip-switch, jumper. Alternatively, the input may be part of control panel 32.

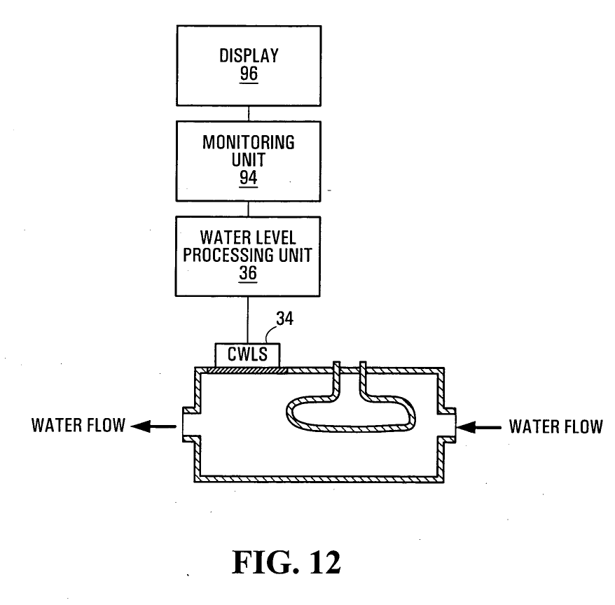

Optionally, the processing unit 36 may also be operative to generate a status signal conveying information associated to the level of water in the heating module 14 and to transmit the status signal to a monitoring unit for conveying the information to an individual. With reference to FIG. 12, the processing unit 36 is shown to be in communication with a monitoring unit 94 having a display unit 96, such as an LED or a LCD display, and/or an audio unit.

For example, the information conveyed by the status signal and displayed on the display unit 96 may include the level of water in the heating module 14.

Alternatively, the processing unit 36 generates a status signal indicative of whether the level of water in the heating module 14 is at least at a threshold level and transmits this status signal to the monitoring unit 96 for conveying to the individual whether the level of water is at least at the threshold level. For instance, when the signal indicative of the water level in the heating module 14 indicates that the water level has fallen below the threshold level, the status signal generated by the processing unit 36 may cause a visual alarm indication to be displayed on the display unit 96 and/or an audio alarm to be emitted by the audio unit 98. The monitoring unit 94 may be located on or in the viscidity of the heating module 14, or alternatively, at a remote location such as on a remote spa control panel or as part of the control panel 32 (shown in FIG. 2).

In another alternative implementation, the processing unit 36 generates a status signal indicating a selected threshold level of water in the heating module 14 from a plurality of threshold levels of water. For example, a first threshold level may indicate that the level of water in the heating module is only moderately reduced, which may be caused by a dirty filter or other obstruction but that the water level is not sufficiently low for the heater to be deactivated. A second threshold level may indicate that the level of water in the heating module is low and that the heater is or will be deactivated. In a practical implementation, display unit 96 may include a set of LEDs or an Alphanumeric message on the display associated to respective threshold levels. Advantageously, by providing an indication of the level of water on display unit 96, the user can detect a problem associated with the water level in the water heater below the water level becomes too low. Optionally, such a water level indication may be associated with a maintenance action such as the cleaning the spa filter.

The above description of the embodiments should not be interpreted in a limiting manner since other variations, modifications and refinements are possible within the spirit and scope of the present invention. The scope of the invention is defined in the appended claims and their equivalents.

1. A control system suitable for use in a bathing unit, said control system comprising:
a) a heating module including a body defining a passage through which water can flow;
b) a capacitive water level sensor adapted for obtaining a capacitance measurement associated to a level of water in the heating module;
c) a processing unit in communication with said capacitive water level sensor for generating a control signal on the basis of the capacitance measurement, said control signal being operative for controlling the heating module.

2. A control system as defined in claim 1, wherein the body of said heating module includes an electrically non-conductive portion.

3. A control system as defined in claim 1, wherein the body of said heating module is comprised of an electrically non-conductive material.

4. A control system as defined in claim 2, wherein said capacitive water level sensor includes:
a) an RC oscillator adapted for releasing a signal characterized by an oscillating frequency;
b) a processing module adapted for processing the signal released by said RC oscillator to derive the capacitance measurement at least in part on the basis of the oscillating frequency.

5. A control system as defined in claim 2, wherein said capacitive water level sensor includes:
a) a capacitor element; and
b) a capacitance measurement device in communication with said capacitor element, said capacitance measurement device being operative to derive the capacitance measurement by obtaining a measurement of a capacitance associated to the capacitor element.

6. A control system as defined in claim 5, wherein said capacitance measurement device is adapted for:
a) applying a current to said capacitor element;
b) measuring a duration of time for a voltage drop across the capacitor element to go from an initial voltage to a final voltage;
c) generating the measurement of the capacitance associated to the capacitor element at least in part on the basis of the measured duration of time.

7. A control system as defined in claim 5, wherein said capacitor element includes a first electrically conductive member and a second electrically conductive member, said first electrically conductive member and said second electrically conductive member being connected to the electrically non-conductive portion of the body of the heating module in a capacitive relationship with one another.

8. A control system as defined in claim 7, wherein the electrically non-conductive portion of the body of said heating module includes an outer surface and an inner surface, said first electrically conductive member and said second electrically conductive member being connected to the outer surface of said heating module.

9. A control system as defined in claim 7, wherein said capacitor element is adapted to acquire a plurality of capacitance values, the capacitance values corresponding to levels of water in a range of levels of water.

10. A control system as defined in claim 9, wherein the range of levels of water is a first range of levels of water, said heating module being adapted to contain a level of water in a second range of levels of water, the first range of levels of water being a subset of the second range of levels of water.

11. A control system as defined in claim 1, wherein said processing unit is adapted to generate a control signal for causing said heating module to be deactivated when the capacitance measurement is associated to a water level below a threshold water level.

12. A control system as defined in claim 1, wherein said processing unit is adapted to generate a control signal for allowing said heating module to be activated when the capacitance measurement is associated to a water level of at least a threshold water level.

13. A control system as defined in claim 1, wherein said processing unit is operative for:
a) generating a status signal conveying information associated to a level of water in said heating module;
is b) transmitting said status signal to a monitoring unit for conveying said information to a human operator.

14. A control system as defined in claim 13, wherein said information conveyed by the status signal includes the level of water in the heating module.

15. A control system as defined in claim 1, wherein said processing unit is operative for:
a) generating a status signal indicative of whether the level of water is at least at a threshold water level;
b) transmitting said status signal to a monitoring unit for conveying to a human operator whether the level of water is at least at the threshold water level.

16. A spa system comprising:
a) a spa shell defining a receptacle for holding water;
b) a heating module in fluid communication with the receptacle defined by said spa shell, said heating module including a body defining a passage through which water can flow;
c) a capacitive water level sensor adapted for obtaining a capacitance measurement associated to a level of water in the heating module;
d) a processing unit in communication with said capacitive water level sensor for generating a control signal on the basis of the capacitance measurement, said control signal being operative for controlling the heating module.

17. A spa system as defined in claim 16, wherein the body of said heating module includes an electrically non-conductive portion.

18. A spa system as defined in claim 16, wherein the body of said heating module is comprised of an electrically non-conductive material.

19. A spa system as defined in claim 17, wherein said capacitive water level sensor includes:
a) an RC oscillator adapted for releasing a signal characterized by an oscillating frequency;
b) a processing module adapted for processing the signal released by said RC oscillator to derive the capacitance measurement at least in part on the basis of the oscillating frequency.

20. A spa system as defined in claim 17, wherein said capacitive water level sensor includes:
a) a capacitor element; and
b) a capacitance measurement device in communication with said capacitor element, said capacitance measurement device being operative to derive the capacitance measurement by obtaining a measurement of a capacitance associated to the capacitor element.

21. A spa system as defined in claim 20, wherein said capacitance measurement device is adapted for:
a) applying a current to said capacitor element;
b) measuring a duration of time for a voltage drop across the capacitor element to go from an initial voltage to a final voltage;
c) generating the measurement of the capacitance associated to the capacitor element at least in part on the basis of the measured duration of time.

22. A spa system as defined in claim 20, wherein said capacitor element includes a first electrically conductive member and a second electrically conductive member, said first electrically conductive member and said second electrically conductive member being connected to the electrically non-conductive portion of the body of the heating module in a capacitive relationship with one another.

23. A spa system as defined in claim 22, wherein the electrically non-conductive portion of the body of said heating module includes an outer surface and an inner surface, said first electrically conductive member and a second electrically conductive member being connected to the outer surface of said heating module.

24. A spa system as defined in claim 22, wherein said capacitor element is adapted to acquire a plurality of capacitance values, the capacitance values corresponding to levels of water in a range of levels of water.

25. A control system as defined in claim 24, wherein the range of levels of water is a first range of levels of water, said heating module being adapted to contain a level of water in a second range of levels of water, the first range of levels of water being a subset of the second range of levels of water.

26. A spa system as defined in claim 25, wherein said processing unit is adapted to generate a control signal for causing said heating module to be deactivated when the capacitance measurement is associated to a water level below a threshold water level.

27. A spa system as defined in claim 25, wherein said processing unit is adapted to generate a control signal for allowing said heating module to be activated when the capacitance measurement is associated to a water level of at least a threshold water level.

28. A spa system as defined in claim 16, wherein said spa system further comprises:
a) a user interface in communication with said processing unit, said user interface being adapted for conveying information to a human operator;
wherein said processing unit is operative for:
i. generating a status signal conveying information associated to a level of water in said heating module;
ii. transmitting said status signal to said user interface for conveying said information associated to the level of water in said heating module to a human operator.

29. A spa system as defined in claim 28, wherein said user interface is adapted for conveying information to a human operator in a visual format.

30. A spa system as defined in claim 28, wherein said user interface is adapted for conveying information to a human operator in an audio format.

31. A spa system as defined in claim 28, wherein the status signal conveying information associated to a level of water in said heating module indicates whether the level of water is at least at a threshold water level.

32. A control system suitable for use in a bathing unit, said control system comprising:
a) heating module means through which water can flow;
b) capacitive water level sensor means adapted for obtaining a capacitance measurement associated to a level of water in the heating module means;
c) means for generating a control signal on the basis of the capacitance measurement, said control signal being operative for controlling the heating module means.

33. A control system suitable for use in a bathing unit, said control system comprising:
a) a device having a body defining a passage through which water can flow;
b) a capacitive water level sensor adapted for obtaining a capacitance measurement associated to a level of water in the device;
c) a processing unit in communication with said capacitive water level sensor for generating a control signal on the basis of the capacitance measurement, said control signal being operative for controlling the device.

34. A control system as defined in claim 33, wherein said device includes a heating module.

35. A control system as defined in claim 33, wherein said device includes a pump.

36. A control system suitable for use in a bathing unit, the bathing unit having a heating module including a body defining a passage through which water can flow, said control system comprising:
a) a capacitive water level sensor adapted for obtaining a capacitance measurement associated to a level of water in the heating module;
b) a processing unit in communication with said capacitive water level sensor for generating a control signal on the basis of the capacitance measurement, said control signal being operative for controlling the heating module.
